(19) United States
(12) Patent Application Publication
(10) Pub. No.: US 2019/0297868 A1
(43) Pub. Date: Oct. 3, 2019

(54) Trap System For Insects

(71) Applicant: Shane Patrick Warner, Saint Petersburg, FL (US)

(72) Inventor: Shane Patrick Warner, Saint Petersburg, FL (US)

(21) Appl. No.: 16/278,160

(22) Filed: Feb. 17, 2019

Related U.S. Application Data
(60) Provisional application No. 62/631,698, filed on Feb. 17, 2018.

(51) Int. Cl. A01M 1/06; A01M 1/02; A01M 1/10

(52) U.S. Cl. CPC A01M 1/06; A01M 1/106; A01M 1/023

(57) ABSTRACT

An insect trap with at least one inflow channel structured and arranged for drawing insects into the housing, and at least one outflow channel structured and arranged to direct airflow to atmosphere. A region between the inflow channel and outflow channel provides space for the user to place textile containing human odor as the insect attractant, or artificial human odor, or any other insect attractant. A suction source is located within the housing and in fluid communication with the inflow channel, the region where attractant is located, and the outflow channel. An insect disabling structure is located between the inflow channel and outflow channel.

### FIELD OF THE INVENTION

The present invention relates to an insect trap for attracting and killing insects, specifically mosquitoes, where the user places textile containing human odor in the trap as an attractant to lure mosquitoes or other insects inside the trap, and thereafter disables and kills the insects.

### BACKGROUND OF THE INVENTION

Suction traps have been used in many different configurations to kill insects in the art. Some insect traps use insect attractants such as light, chemical attractants, heat, gas, moisture, or other insect attractants. These insect attractants would lure insects close enough to the trap, where an inflow of air would suck them into a mesh screen, which they cannot escape, and eventually die.

Many insect traps are not effective in trapping mosquitoes in particular, and require a lot of maintenance by the user. For example, one insect trap converts propane gas into carbon dioxide to attract insects. The propane tank has to be filled often and is expensive to fill. This insect trap also needs to be cleaned every time the propane tank is replaced. Some other insect traps claim a light source attracts mosquitoes, however it commonly attracts and kills moths/lepidoptera, which are good for the environment.

There is currently no insect trap designed specifically for the user to conveniently place textile containing human odors, such as clothing, rug mats, or bed sheets, into the trap as attractant, specifically to draw mosquitoes in the trap, and thereafter disable and kill the mosquitoes.

Using insect attractants such as light, chemical attractants, heat, gas, moisture, and many other insect attractants significantly increase the cost to manufacture and assemble the insect trap, resulting in a more expensive price to the user than necessary. Many of these insect traps require maintenance and recurring cost to purchase insect attractants for the trap, adding more inconvenience to the user.

Many insect traps do not direct the outflow of insect attractant parallel with the ground. However, doing so attracts insects from areas further away from the trap, and thus captures and kills more insects as opposed to an outflow of insect attractant perpendicular to the ground.

There is a need in the art for a practical mosquito trap designed for applying the user's textile containing human odors or artificial human odor as an attractant in the trap. There is also a need for the mosquito trap to be convenient to the user for placing and replacing the attractant, low user maintenance, and reasonably priced.

### SUMMARY OF THE INVENTION

The insect trap of the present invention is designed for the user to conveniently place and replace textile containing human odor or artificial human odor as the insect attractant. The outflow of insect attractant is directed parallel to the ground, drawing insects from all areas near the trap to the inflow channels, where these insects are sucked into the trap and eventually die. This simple, yet effective insect trap needs relatively few molded parts, making for quick assembling, and thus an inexpensive price for the user. The nature of the attractant used in this invention specifically targets mosquitoes, and not other insects that are good for the environment, such as lepidoptera.

One embodiment of the present invention includes: a trap housing; a flow mechanism; an insect disabling structure; a structure for securing the suction source and the insect disabling structure to the trap housing; and a central region where the user can conveniently place textile containing human odor or artificial human odor.

The trap housing is made up of a substantially annular-shaped apparatus, a lid housing that snaps onto the lip of the annular-shaped apparatus, and a top housing that fastens on top of the lid housing. The annular-shaped apparatus contains at least one outflow channel, a central region where textile containing human odor, perspiration, dead skin, hair, or anything artificial of the like is provided and inserted by the user. The annular-shaped apparatus also provides a convenient lip for the lid housing to snap onto. The lid housing snaps onto the annular-shaped apparatus and provides a structure to hold the weight of the suction source and allows for air to flow from the inflow channels to the central region, where the insect attractant is located. The top housing provides: a structure that allows for inflow of air; protection from weather deterioration of the suction source; and mounting brackets to secure the suction source in place. Once assembled, the top housing and lid housing together will easily be removed and attached to the annular-shaped apparatus so the user can conveniently place and replace insect attractants.

The flow mechanism is comprised of a suction source such as a fan and at least one inflow channel and at least one outflow channel. The inflow communicates with the central region where the insect attractant is located, and the central region communicates with the outflow channel. The inflow channel provides a path to ingress the insects into the trap housing where the insects get trapped by the insect disabling structure. Airflow from atmosphere combines with the insect attractant inside the trap housing and directed to the outflow channels. This airflow mixed with insect attractant is directed outward from the trap and parallel to the ground. This will attract insects from areas surrounding the trap. Once insects are attracted close enough to the trap, they will be sucked through the inflow channel, through the suction source, and finally into an insect disabling structure where they will be trapped and eventually die.

The insect disabling structure allows airflow to pass through; however, prevents insects from passing through. This structure is attached to the suction source.

A structure for securing the suction source and insect disabling structure to the trap housing is needed to create the flow mechanism aforementioned. This is achieved by mounting brackets built into the top housing. Fasteners join the insect disabling structure to the suction source, and suction source to the top housing's mounting brackets as well.

A central region inside the annular-shaped apparatus provides space for the user to place textile containing human odor or artificial human odor as the insect attractant. Any other insect attractant may be used in this region as well.

### BRIEF DESCRIPTION OF THE DRAWINGS

FIG. 1 is a perspective view of one embodiment of an insect trapping system according to the present invention;

FIG. 2 is an exploded perspective view in the direction of arrow 12 in FIG. 1;

FIG. 3 is a top plan, sectional view of line 64-64 of FIG. 1; and

FIG. 4 is a sectional view of line 62-62 of FIG. 3.

### DETAILED DESCRIPTION OF THE INVENTION

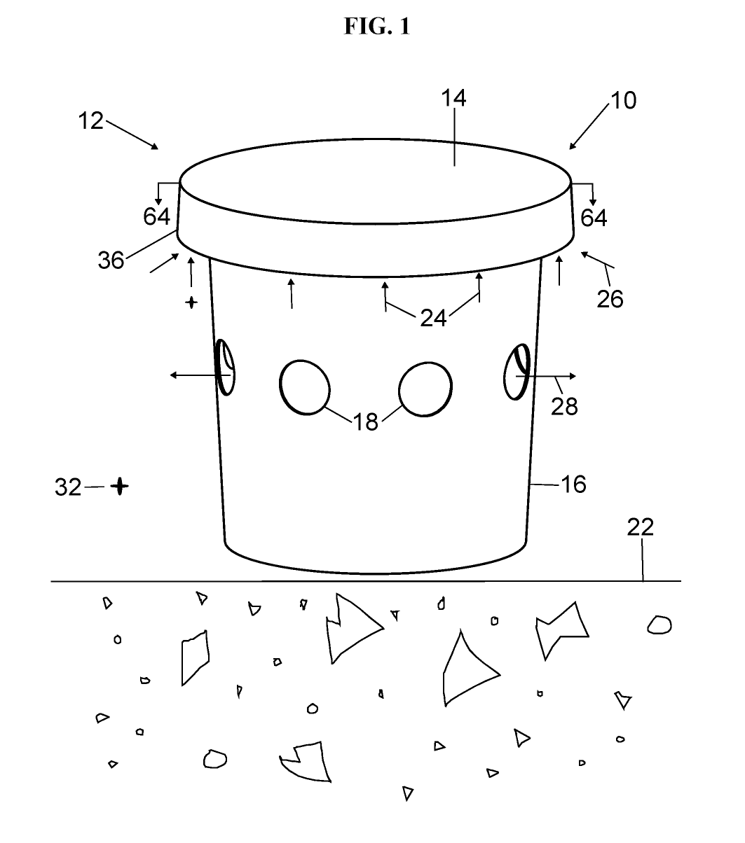

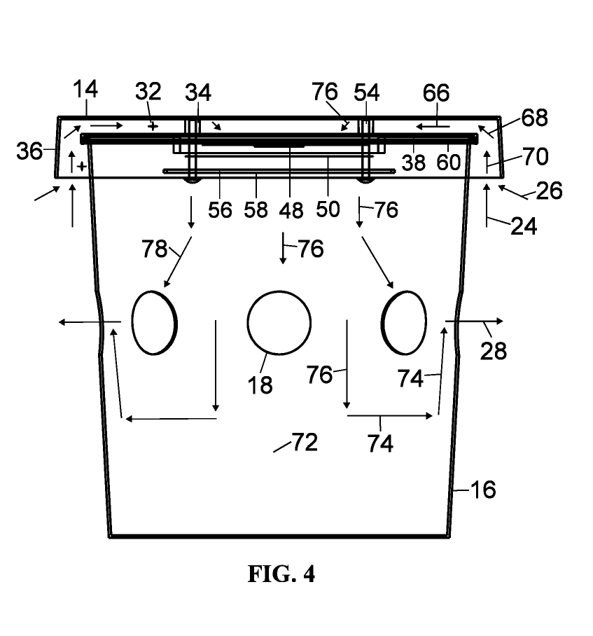

The insect trap of the present invention is generally denoted by reference numeral 10 of FIG. 1. Directional references to the insect trap refer to the orientation shown in FIG. 1. Referring to FIG. 1, mosquitoes 32 and other insects are attracted to the exhaust outflow 28. The inflow channels 24 draw air in from atmosphere 26. When mosquitoes 32 or other insects are close enough to the trap, they will be sucked in through the inflow channels 24. Shown in FIG. 4, the insects then follow the inlet air stream 70 outside of the annular-shaped apparatus 16, but inside the top housing's vertical segment 36. Air flow is then redirected horizontally 68 and continues through the horizontal channel 66. As air flows through the horizontal channel 66, it flows around the top housing's mounting brackets 34, which are fastened to the lid housing 38 via fasteners 54. Air flow is then directed downward 76 through the fan 48 and through the mesh screen 56, where insects are snared, but air is still able to flow through. Air flow is then directed into the central region 72. Textile containing human odor or artificial human odor is to be provided and placed by the user in the central region 72 as the attractant for trapping insects. Air flowing into the central region 72 mixes with the attractant and is blown towards the exhaust outflow 28. The textile is not to obstruct the outflow channels 18 in any way. As the outflow of air mixed with attractant 74 exits the insect trap 10, it will attract and draw mosquitoes 32 or other insects to the insect trap 10, and once close enough, they will be sucked through the inflow channels 24. Due to the design, consequently some of the air flow directed downward 76 exits the trap 78 without mixing with the attractant first. The power cord 20 is to be plugged into the appropriate power source to power the fan 48. The insect trap 10 is designed to rest on the ground 22.

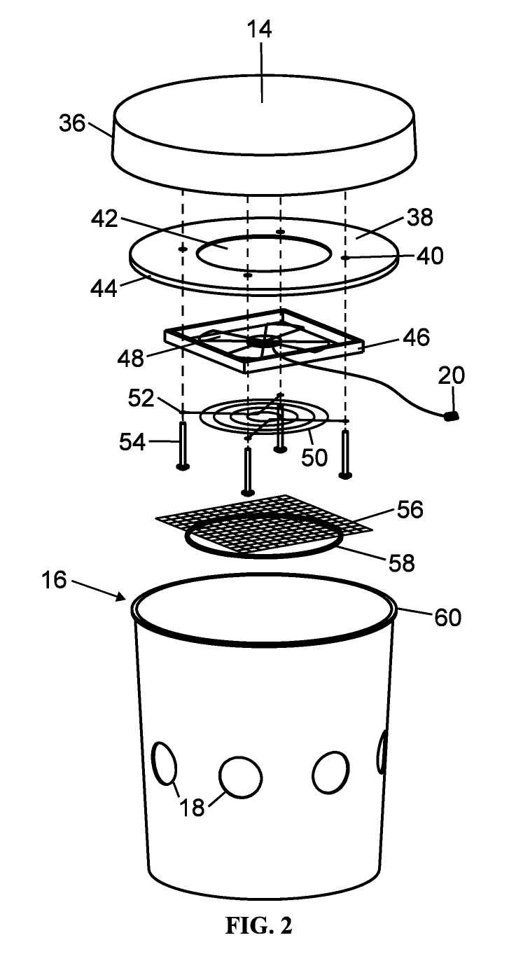

Referring to FIG. 2, the annular-shaped apparatus 16 provides features that include: housing the attractant with the central region 72; provides outflow channels 18; contains a lip 60 for snap fitting the lid housing 38; and is the base structure that is responsible for supporting the weight of all other parts directly or indirectly. A durable plastic is the preferred material for the annular-shaped apparatus 16.

The lid housing 38 is to snap on top of the annular-shaped apparatus 16 by the lip 44 of the lid housing 38. The lid housing 38 accomplishes multiple tasks that include: allows air to flow from the fan 48 to the central region 72 through the lid housing's central segment 42; contains lid housing holes 40 for fasteners 54 to pass through and fasten to the top housing 14; and provides support for the top housing 14, fan 48, fan grill guard 50, fasteners 54, mesh screen 56, and plastic fastener 58. A durable plastic is the preferred material for the lid housing 38.

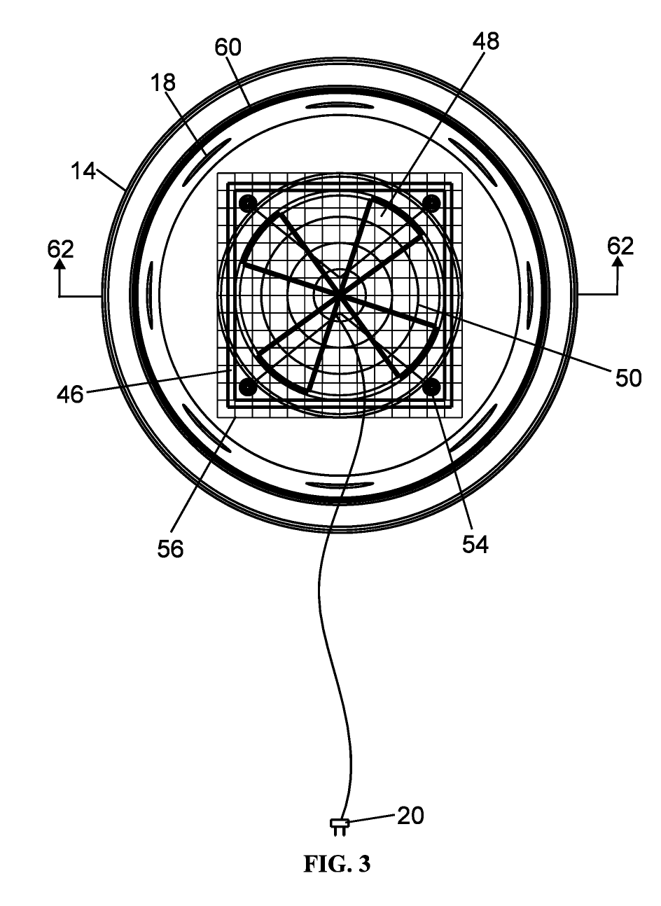

The top housing's 14 primary purpose is to provide one or more inflow channels 24. However, it also serves as part of the housing to protect against weather degradation. As shown in FIG. 4, the top housing 14 provides the top housing mounting brackets 34 for fasteners 54 to mount to. The fasteners 54 are to support and secure the fan grill guard 50 and the the fan 48 against the lid housing 38 so there is no space for mosquitoes to escape around the perimeter of the fan 48. This is achieved by feeding the fasteners 54 through the fan grill guard mounting holes 52, fan housing 46, and lid housing holes 40 to mount to the top housing's mounting brackets 34. The mesh screen 56 is arranged around the fan housing 46 and a plastic fastener 58 secures the mesh screen 56 to the fan housing 46, also shown in FIG. 3. A durable plastic is the preferred material for the top housing 14.

The summarized and detailed embodiments of the present invention will be understood not to limit the scope of any such embodiments and applications. It is understood that any substitutions and variations of the system, structure, and method described herein can be made by those skilled in the art without departing from the essence of the present invention.

What is claimed is:

1. An insect trapping system, comprising:
an insect trap housing with at least one inflow channel structured and arranged for drawing insects into the said housing, and at least one outflow channel structured and arranged to direct airflow toward atmosphere;
a region within said housing that provides space for textile as the insect attractant, which may contain human odor, or this region may contain artificial human odor, or this region may contain any other insect attractant;
a suction source within said housing, and in fluid communication with said at least one inflow channel, the region within said housing where attractant is located, and said at least one outflow channel.

2. The trapping system of claim 1 wherein said suction source is comprised of a fan mechanism arranged to exhaust airflow to atmosphere.

3. The trapping system of claim 1 wherein the said housing is partially constructed of a substantially annular-shaped apparatus housing.

4. The trapping system of claim 1 wherein the said housing is partially constructed of a lid housing with the capability to conveniently snap on and off said annular-shaped apparatus housing.

5. The trapping system of claim 1 wherein the said housing is partially constructed of a top housing that directs air inflow toward the said region within said housing where attractant is located and additionally protects the suction source from weather degradation.

6. The trapping system of claim 1 wherein an insect disabling structure is arranged between said at least one inflow channel and said at least one outflow channel.

7. The trapping system of claim 6 wherein said insect disabling structure is comprised of mesh screen.
